(19) United States
(12) Patent Application Publication
(10) Pub. No.: US 2023/0107792 A1
(43) Pub. Date: Apr. 6, 2023

(54) Reduced Noise and Vibration Switched Reluctance Machine With a Defined Stator Rotor Relationship

(71) Applicant: Turntide Technologies Inc., Sunnyvale, CA (US)

(72) Inventors: Piyush Desai, Des Plaines, IL (US); Tim Knodel, Cupertino, CA (US); Bryan Knodel, Flagstaff, AZ (US); Earl Fairall, Sunnyvale, CA (US); Mark Johnston, Los Altos Hills, CA (US); Mahesh Krishnamurthy, Wheaton, IL (US)

(21) Appl. No.: 18/078,988

(22) Filed: Dec. 11, 2022

Related U.S. Application Data
(63) Continuation-in-part of application No. 16/635,986, filed on Jan. 31, 2020, now Pat. No. 11,532,976.
(60) Provisional application No. 62/658,485, filed on Apr. 16, 2018.

(51) Int. Cl. H02K 5/24; H02K 1/14; H02K 1/24

(52) U.S. Cl. CPC H02K 5/24; H02K 1/146; H02K 1/246; H02K 2201/03; H02K 2213/03

(57) ABSTRACT

A switched reluctance machine comprising at least one rotor comprising a set of rotor poles arranged about a central axis, at least one stator positioned concentric to and radially outward from the central axis and the rotor, the stator having an outer surface and an outer surface active zone; a housing having a sleeve positioned only radially outward from the stator outer surface active zone; at least one housing endplate coupled to an end of said housing; wherein said stator has no direct connection to said housing, and wherein the number of rotor poles Rₙ and number of stator poles Sₙ utilizing a numerical relationship defined by a mathematical formula, Rₙ=2Sₙ−Fₚ, when Sₙ=m×Fₚ, wherein Fₚ is the maximum number of independent flux paths in the stator when stator and rotor poles are fully aligned, and m is the number of phases.

### RELATED APPLICATIONS

This application is a continuation in part of U.S. patent application Ser. No. 16/635,986, filed Jan. 31, 2020, which claims priority under 35 U.S.C. Section 371 to PCT Application PCT/US2019/027749, filed Apr. 16, 2019, which claims the benefit of provisional application with Ser. No. 62/658,485 and filed Apr. 16, 2018. The disclosure of that provisional application is incorporated herein as if set out in full.

### BACKGROUND OF THE DISCLOSURE

### Technical Field of the Disclosure

Recent advances in electromagnetic simulation capabilities and power electronics have made switched reluctance motor (SRM) an attractive candidate for electric motor applications. Positive aspects of SRM drives include their inherent variable speed capability over a wider operating range, simple construction, robust performance, and low manufacturing cost. An SRM is a brushless, synchronous machine having salient rotor and stator poles. There is a concentrated winding on each of the stator poles, but no windings or permanent magnets on the rotor. The SRM can have several combinations of stator poles and rotor poles, where the rotor typically has fewer poles than the stator. The pairs of diametrically opposite stator pole windings are connected in series or in parallel to form an independent machine phase winding of the multi-phase SRM. Ideally, the flux entering the rotor from one stator pole balances the flux leaving the rotor from the diametrically opposite stator pole, so that there is no mutual magnetic coupling among the phases. Torque is produced by switching current in each phase winding in a predetermined sequence that is synchronized with angular position of the rotor. In this way, a magnetic force of attraction results between the rotor poles and stator poles that are approaching each other. The current is switched off in each phase before the rotor poles nearest the stator poles of that phase rotate past the aligned position, thereby preventing the magnetic force of attraction from producing a negative or braking torque. Hence, by properly energizing the phase windings relative to rotor angle, forward or reverse operation and motoring or generating operation can be obtained.

Compared to a conventional SRM, the HRSRM has higher static torque capability, which effectively addresses torque ripple and acoustic noise. The design parameters of the power converters of SRMs and HRSRMs differ. This is because the HRSRM has a different inductance profile and a higher number of strokes. Most reliable techniques for the conventional HRSRM utilize the self-inductance of the phase coil to estimate position. The HRSRM has a higher number of rotor poles for the same circumference as a conventional SRM. The higher number of rotor poles reduces the angular travel per excitation. However, the larger number of rotor poles lead to a smaller gap and the arc length (or angular length) between two rotor poles is smaller. As a result, the self-inductance profile for the HRSRM becomes flatter which leads to unreliable position estimation.

Another conventional approach describes a switched reluctance machine; whether operated as a motor, generator, or both; having a new relationship between the number of stator poles and rotor poles so as to provide a SRM with a minimal amount of torque ripple and acoustic noise while providing improved power density and torque production. This invention provides a SRM having a salient rotor and stator pole numerical relationship of S number of stator poles, where S>2, and R number of rotor poles, which can be expressed as R=2S−2, such as an S/R pole count in a 6/10, 8/14, or 10/18 configuration. Also, while the invention is described in relation to an exemplary form of rotary machines, it is equally applicable to other forms of rotary machines and to linear and inverted machines as well. Though, the approach describes one specific formula, which describes only one possible number for rotor poles for a given number of stator poles. As an example, 16 stator poles would lead to 30 rotor poles.

Another approach describes an SRM that supports one or more phases, each phase comprising a stator, a rotor and coils. The stator is hollow, cylindrical and comprises stator poles extending inwards, such that a recess is formed between adjacent stator poles. The coils are wound on the stator poles and occupy the recess. The rotor is positioned inside the stator and has poles extending outwards. The rotor and stator poles subtend an angle having a maximum value of 0.5 electrical pole pitches at a center of rotation. The different phases are distributed along the axis of the SRM. The rotor is rotated by a reluctance torque generated by energizing a phase in a current controlled manner until the rotor rotates through a minimum commutation angle required to maintain motion; de-energizing the phase by freewheeling it by using the energy stored in it and simultaneously energizing a second sequentially adjacent phase. This conventional approach only duplicates combinations of rotor and stator and does not present any relation between the magnetic circuit (flux path) and the number of stator or rotor poles in the machine.

Yet another approach describes a two-phase switched reluctance machine, the machine using discontinuous core structures as the stator for effective use as part of low-cost, high-performance drives. This discontinuous stator core structure contains short flux paths and maximum overlap between the rotor poles and stator poles in the stator discontinuous core structures, regardless of the rotor position. Example configurations of such core structure include E-core, L-core and I-core configurations. Using less steel and magnet wire than in conventional SRM designs results in cost savings of stator material and winding material. Efficiency of this novel SRM is improved because of shorter flux paths resulting in reduction of core losses and decreased phase resistance resulting in reduction of copper losses. Two-phase simultaneous excitation of the novel SRM can reduce torque ripple during commutation as compared with existing two-phase SRMs. This conventional approach introduces one more geometric shape for the HRSRM with reduced stator, however, it does not show any electromagnetic relation that can be used to predict different configurations.

Therefore, there is a need for a high rotor pole switched reluctance machine (HRSRM) comprising a higher number of rotor poles than stator poles and which would be capable of addressing the issues of high torque ripple and acoustic noise. Such a switched reluctance machine would enable a minimal amount of torque ripple and would further enhance torque quality of the machine. Such an HRSRM would provide a plurality of combinations of the rotor poles and stator poles utilizing a numerical relationship defined by a specific mathematical formula. Such a machine would facilitate improved noise performance and design flexibility. The present embodiment overcomes the aforementioned shortcomings in this area by accomplishing these critical objectives.

### SUMMARY OF THE DISCLOSURE

A switched reluctance machine (“SRM”) is a rotating electric machine and, due to its rugged and robust construction coupled with available fine motor control options, is a viable candidate for myriad generator and motor control applications. In an SRM, both stator and rotor have salient poles and power is delivered to windings in the stator, rather than the rotor as in conventional motors/generators. In operation, the SRM runs by reluctance torque, where rotor position is rotationally urged by voltage strokes and the accompanying magnetic communication between rotor and stator. In an SRM, the phase windings may be found on the stator, unlike the rotor which is unexcited and has no windings or permanent magnets mounted thereon. Rather, the rotor of an SRM is formed of a magnetically permeable material, typically iron, which attracts the magnetic flux produced by the windings on the stator poles when current is flowing therethrough.

Although an SRM may act as either a switched reluctance generator or switched reluctance motor, in motor form magnetic attraction to the stator causes the rotor to rotate when excitation to the stator phase windings is switched on and off in a sequential fashion in correspondence to the rotor position. In generator form, the load is switched to the coils in such a sequence to synchronize current flow with rotation.

While an SRM is in some ways simpler than a conventional motor because power need not be delivered to a rotating part, it is at the same time more complicated because power must be delivered to different windings at different times. A switching system, such as an electro-mechanical means such as commutators or analog or digital timing circuits are typically employed to accomplish this necessary fine control.

While the conventional SRM provides many advantages over conventionally configured electric motors and generators, SRMs in many cases exhibit high levels of torque ripple, which in practice leads to unacceptable levels of noise and vibration. In an SRM, when the stator windings are energized, the solid salient-pole rotor's magnetic reluctance creates a force that urges its rotation. As certain stator poles are energized, typically diametrically opposed, the rotor moves toward alignment with those poles. As this occurs, the poles are de-energized, and the next step of stator poles are energized. The forces acting on the rotor actually very slightly deform the rotor into something more similar to an elliptic cylinder. Although as a percentage of the whole, the deformation is very mild, it is sufficient to create waves within the housing which are then transferred through the motor output as measurable vibrations. The pressure waves further manifest themselves as measurable sound emanating from the motor casing.

Various means of minimizing torque ripple have been employed. Dampening and insulation may reduce audible noise and vibration. Most modern SRMs employ programmable logic controllers, and thus can precisely time phase activations to minimize nonrotational movement. Because the rotor position can be exactly known, specific controller technology can further reduce torque ripple when it occurs. However, noise and vibration still occur, typically appearing as physical shaking of the motor on its mounts, and noise energy emitted from the SRM housing.

Therefore, there is a need for an SRM exhibiting reduced noise and vibration through the isolation of its stator/rotor mechanisms.

To that end, it is a first objective of the present invention to provide an SRM comprising a gap between all or substantially all of the stator outer surface and all or substantially all of the housing radially outward from said surface.

It is a second objective of the present invention to provide an SRM wherein the stator/rotor mechanism is only supported by bridges connecting to housing endplates.

It is a third objective of the present invention to provide an SRM wherein the stator and rotor are maintained in alignment by means other than an SRM housing.

It is a further objective of the present invention to provide an SRM wherein the stator is mechanically connected to the housing only via an intermediate structure.

It is a still further objective of the present invention to provide an SRM wherein the stator and housing are not contiguous.

It is a still further objective of the present invention to provide an SRM wherein the stator is coupled to the housing only through a housing endplate.

It is a still further objective of the present invention to provide an SRM according to an alternative embodiment wherein the stator is radially inward from said rotor, which is not contiguous with the SRM housing.

The present embodiment overcomes shortcomings in the field by accomplishing these critical objectives.

To minimize the limitations found in the existing systems and methods, and to minimize other limitations that will be apparent upon the reading of this specification, the preferred embodiment of the present invention provides a method for reducing noise in a switched reluctance machine further provides for a related apparatus of a switched reluctance machine exhibiting reduced noise.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a diagrammatic view of an SRM showing stators in phase and an associated rotor with two rotor poles aligned;

FIG. 2 is a diagrammatic cross sectional prior art image of a conventional SRM with certain elements shown removed for clarity;

FIG. 3 is a diagrammatic cross sectional view of the SRM according to the preferred embodiment, with certain elements shown removed for clarity;

FIG. 4 is a front perspective view of an SRM exhibiting decreased noise in accordance with a preferred embodiment of the invention;

FIG. 5 is a front view of the SRM according to the preferred embodiment;

FIG. 6 is a right-side view of the SRM according to the preferred embodiment;

FIG. 7 is a bottom side view of the SRM according to the preferred embodiment and with the fan shroud shown removed;

FIG. 8 is a front perspective view of the SRM according to the preferred embodiment wherein the housing, end plates, fan, fan shroud, and feet are removed;

FIG. 9A is a front perspective view of the SRM according to the preferred embodiment wherein the end plates, fan, fan shroud, and feet are removed;

FIG. 9B is the same image depicted in FIG. 9A but wherein the sleeve portion of the housing is depicted as a darker area along the housing;

FIG. 10 is a diagrammatic cross sectional view of an alternative embodiment of the invention where the rotor is radially outward from the internal stator;

FIG. 11 is midline cross-sectional view of the SRM according to the preferred embodiment wherein housing end plates, fan, and fan shroud are shown removed;

FIG. 12 is a rotated and closer view of the section shown in FIG. 11;

FIG. 13 is a front perspective view of the SRM where for clarity only rotor, stator and stator windings are depicted;

FIG. 14 is a front perspective view of a stator according to some embodiments of the present invention;

FIG. 15 is a front view of the SRM according to the preferred embodiment, and wherein end caps are removed for clarity;

FIG. 16 is a partial perspective front view of an SRM according to an alternative embodiment of the invention, wherein housing end plates, fan, and fan shroud shown removed;

FIG. 17A is a front view of an SRM according to an alternative embodiment of the invention wherein the gap between stator support cylinder and the housing is clearly depicted;

FIG. 17B is a front view of an SRM as shown in FIG. 17A but wherein the gap is filled with a non-gaseous vibration absorbing material;

FIG. 18 is a front perspective view of an SRM according to an alternative embodiment of the invention, wherein the housing is shown removed for clarity;

FIG. 19 is a front perspective view of an SRM according to an alternative embodiment of the invention, wherein housing and housing end plates are shown removed for clarity;

FIG. 20 is a midline cross-sectional view of the SRM wherein housing end plates, fan, and fan shroud are shown removed for clarity;

FIG. 21 is a cross sectional view of an alternative embodiment of the invention;

FIG. 22 is a multi-stator multi-rotor SRM according to some embodiments of the invention;

FIG. 23 illustrates a cross-sectional view of a switched reluctance motor;

FIG. 24 illustrates a 16/28 SRM as an example of the proposed formulation;

FIG. 25 is a 3-D view of the 16/28 SRM as an example of the proposed formulation;

FIG. 26A illustrates 16 stator poles of the 16/28 SRM without coils and rotor assembly in accordance with the preferred embodiment of the present invention;

FIG. 26B illustrates 28 rotor poles for the 16/28 SRM without stator assembly in accordance with the preferred embodiment of the present invention;

FIGS. 27A and 27B show the coil configuration in the 16/28 SRM that can be modified to allow four independent short-flux paths;

FIG. 28 shows a finite element analysis simulation of 16/28 SRM showing an alternate winding combination; and

FIG. 29 is a flowchart that illustrates a method for estimating number of rotor poles for a high rotor pole switched reluctance machine (HRSRM).

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized, and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means +/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

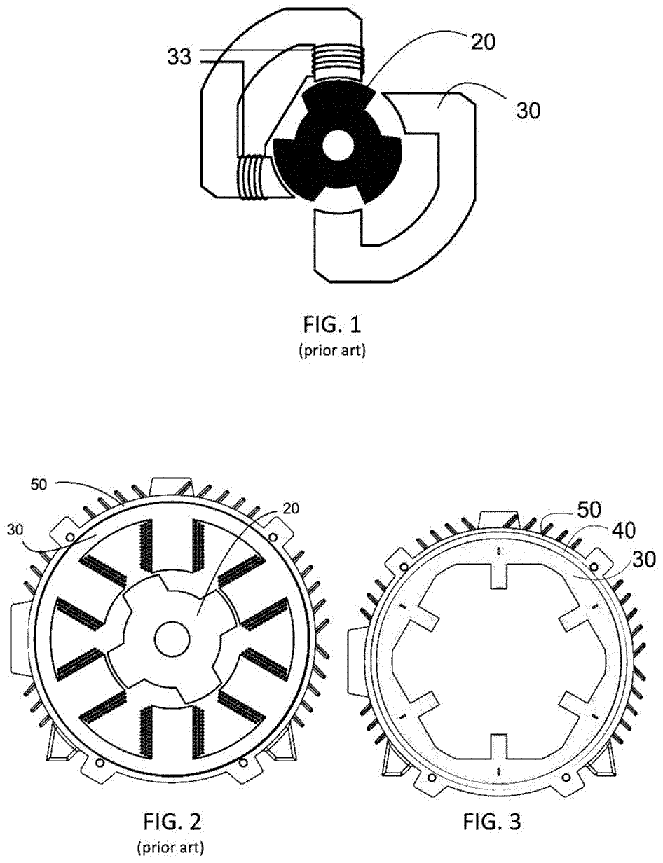

A switched reluctance machine (“SRM”) is a rotating electric machine generally having a configuration shown in its simplest form at prior art FIG. 1. Here, power is delivered to windings in the stator 30, and wherein rotor 20 position is rotationally urged by voltage strokes and the accompanying magnetic communication between rotor and stator. Phase 33 is depicted. The machine may be run either as a motor or in reverse as a generator, and although the apparatus may at times in this document be referred to as a motor, it is to be understood that in reverse the machine may be operated as a generator as well.

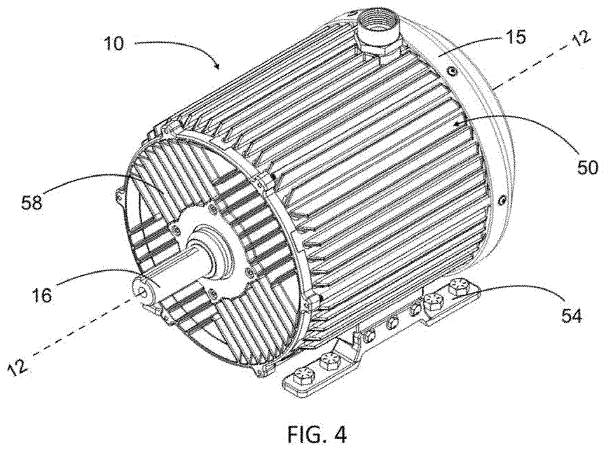

Prior art FIG. 2 depicts a diagrammatic end view of a conventional switched reluctance machine (SRM) with rotor and end cap removed for ease of viewing. This conventional machine shows a very small or no air gap between an outer surface of the stator 30 and an inner surface of the housing 50. As with many motors and generators, heat control is an important factor. To that end, for heat dissipation purposes conventional SRMs typically leave no space between stator and housing. A firm and direct connection of the two components allows the SRM housing to act as a heat sink for the stator/rotor combination. This is achieved by configuring the stator to fit tightly inside the housing.

Turning next to FIG. 3, an improved SRM according to an embodiment of the invention is shown in diagrammatic form. The SRM is provided with a space gap 40 between stator 30 and the housing 50 is shown. More detailed descriptions of the components involved may be found in the subsequent images and text related thereto. Although the gap is referred to here as a space gap, it need not necessarily be filled with air. Instead, as described in alternative embodiments of the invention, the gap may be filled with any noise and/or vibration dampening material, such as gel, or it may be filled with air or other gasses. The material within the gap need not be homologous, and in some alternative embodiments there may exist other material or additional circular rings, scaffolding, or structural supporting material. The additional materials would further reduce noise and/or provide support for the gel, structural assistance generally, ease of manufacturing, or improved heat dissipation. In any case, there is no direct mechanical connection between the stator and the housing segment (sleeve segment).

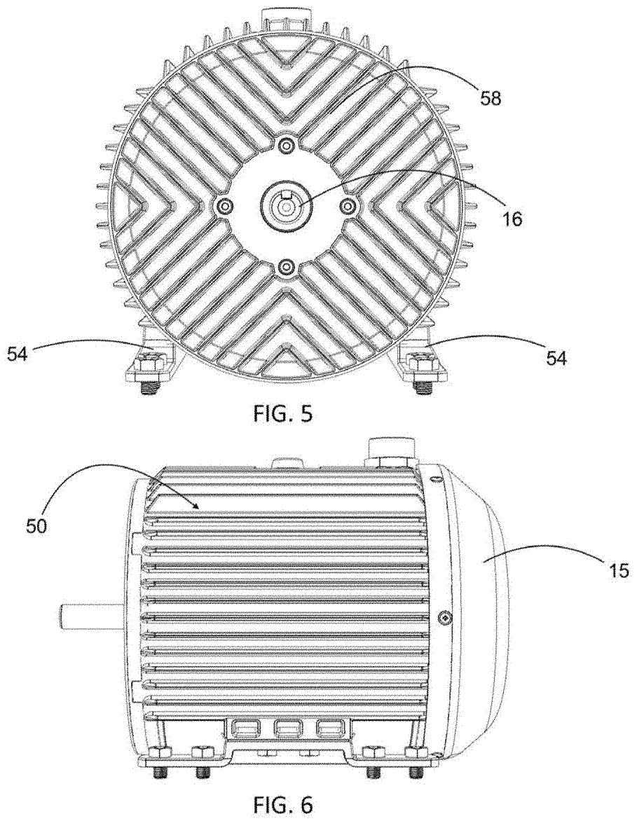

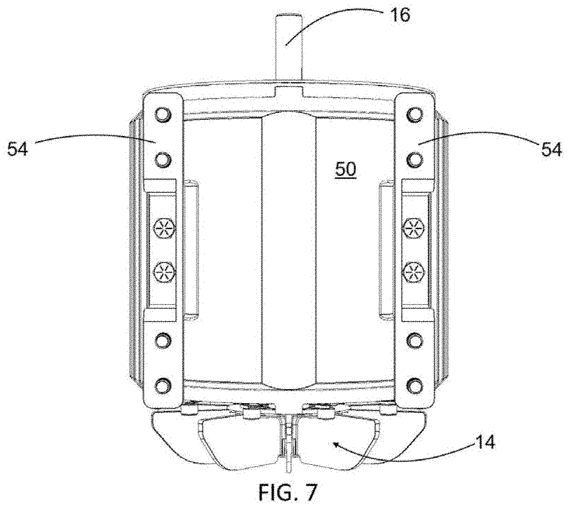

FIGS. 3-15 depict an SRM 10 in accordance with a preferred embodiment of the invention. As shown in FIG. 4-6, the housing 50, feet 54, end cap 58 and fan shroud 15, along with other conventional features appear as they would on conventional SRMs. As shown in FIGS. 5 and 7, output shaft 16 rotates about central axis 12 as a result of operation of the motor, or when the machine is in generator mode output shaft 16 may conceptually be considered an input shaft. Feet 54 or other mounting features serve to anchor the SRM 10 to another object and to minimize its movement in relation thereto. Although they are shown on a middle portion of the housing, similar mounting features may be integral with or coupled to the housing end plates. As shown in FIGS. 4, 6 and 7, feet 54 comprise four fasteners each, however, any suitable means of coupling the SRM 10 to an external object are considered. FIG. 7 depicts the underside of the machine, wherein the fan shroud has been removed, exposing fan 14 insider. In a preferred embodiment, the improved SRM 10 is externally no different from conventional SRMs. This allows the improved SRM 10 to be installed in a plug and play fashion in lieu of a conventional SRM.

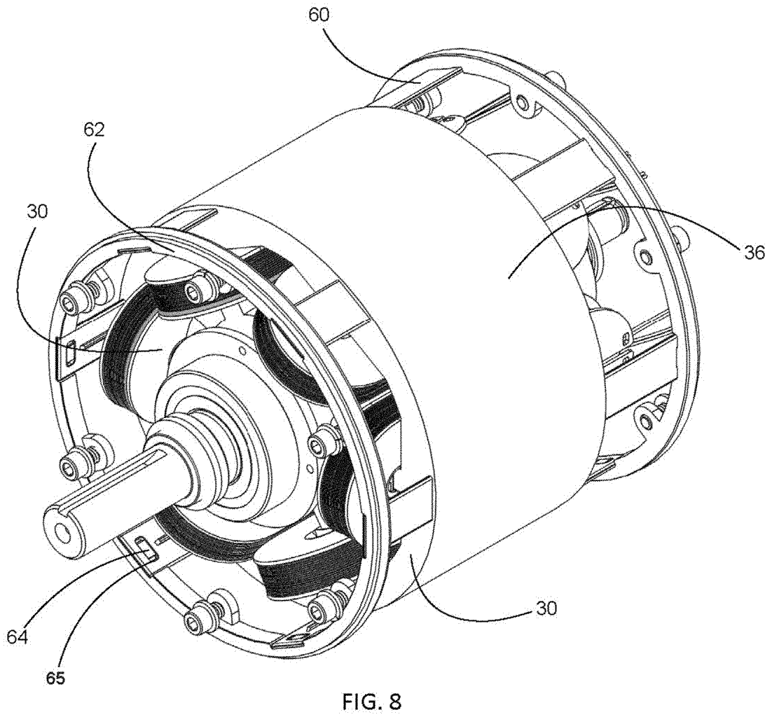

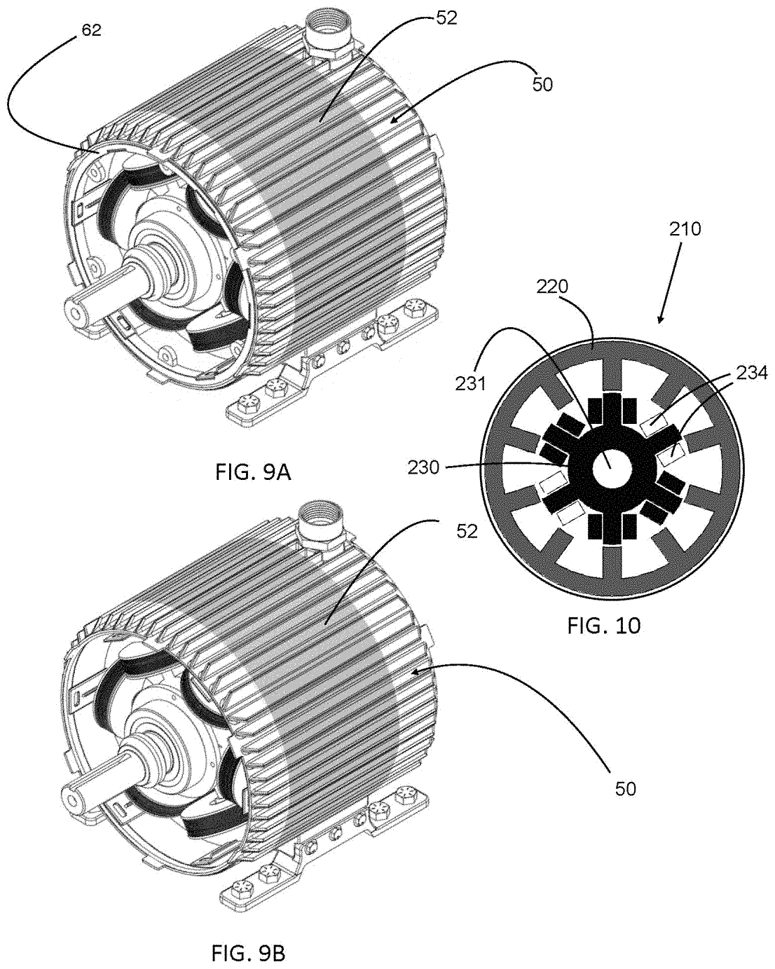

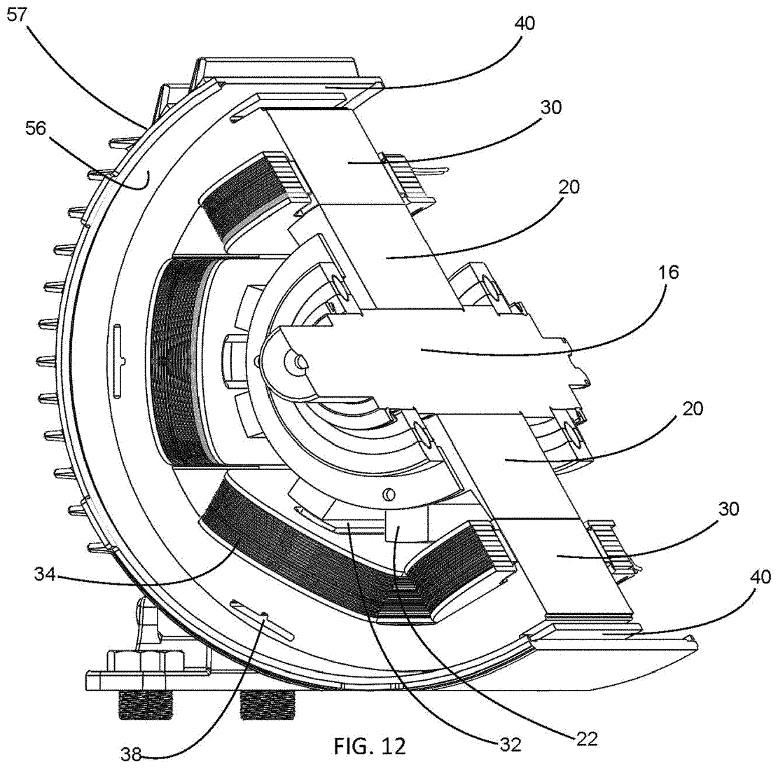

FIG. 8 is a front perspective view wherein the inner workings of the machine are revealed by the removal of housing 50, feet 54, and housing end plates. In the preferred embodiment, the stator 30 is supported by a plurality of connecting bridges 60 that pass through the stator apertures 38 (see FIG. 12). Preferably, the ratio of connecting bridge to stator pole is 1:1, however, there may be fewer or greater numbers of either connecting bridges or stator poles. A pair of connecting bridge rings 62 at each end of the connecting bridge fit over connecting bridge retaining tabs 62 and are used to support the ends of the connecting bridges 60.

Connecting bridge ring 62 is mounted to housing front end plate 58 and the connecting ring at the rear of the machine (not labeled) is similarly coupled to the housing rear end plate (not labeled). Although various means known in the art for coupling components may be used, in the exemplary embodiment shown in FIG. 8, a connecting bridge retaining tab 65 on the connecting bridge ring accepts a connecting bridge aperture 65 on the connecting bridge 60.

FIGS. 9A and 9B are front perspective views of the SRM according to the preferred embodiment but wherein end plates, fan, and fan shroud are shown removed. In FIG. 9A, the connecting bridge retaining ring 62 is in position, whereas in FIG. 9B the machine is shown with this component removed. The connecting ring in an example of an intermediate structure between support bridges and housing, however, other suitable means for coupling the components together may be employed.

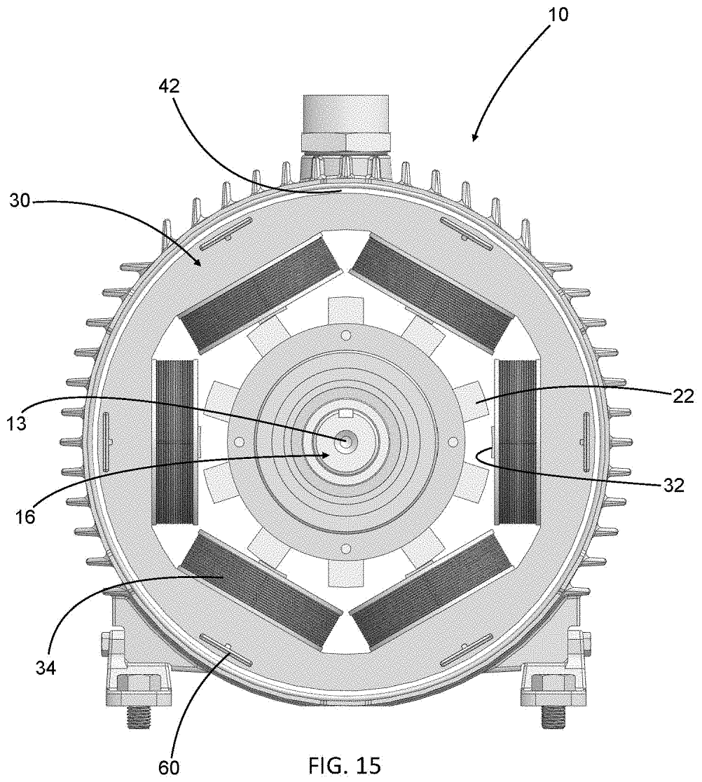

Attention is now turned to FIG. 15, which is a front view of the SRM according to the preferred embodiment. Here, the rotor (not labeled) and a plurality of rotor poles 22 are shown positioned radially inward from said stator 30, which has its own stator poles 32. In use, rotor pole 22 is rotationally urged towards stator pole 32 upon the energization of a pair of windings 34. The rotor/stator combination are kept in alignment to one another by connecting bridges 60, but are also maintained separated from the housing, thus creating a gap that in this instance is an air gap 42. The gap need not be filled with air, and other materials such as other gasses, liquids, solids or semi-solids may be used.

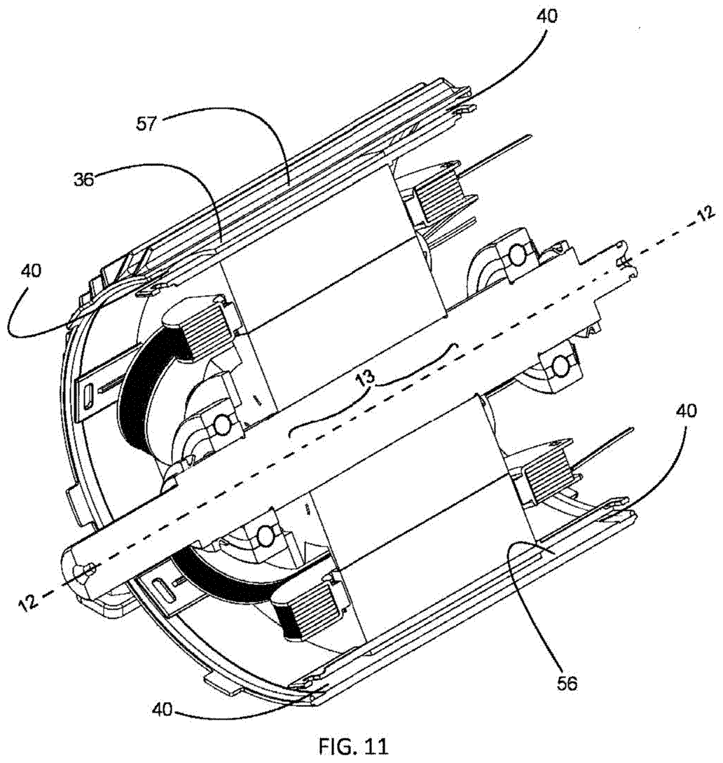

FIG. 11 is a cross sectional view taken down the length of the machine. The central axis 12 is visible, as is that portion of the central axis 12 that passes through the stator/rotor combination, referred to here as central axis active portion 13. Extending radially outward from the active portion, one passes through rotor, then stator, then stator outer surface 36, then gap 40, then sleeve portion inner surface 56 and finally sleeve portion outer surface 57. The sleeve portions are a part of housing 50, not labelled here, and are not necessarily separate components. That is, the sleeve portion 52 (shown best at FIGS. 9A and 9B) is a zone of the housing 50 that corresponds to the central axis active portion 13 at its center. In FIGS. 9A and 9B this is depicted as a shaded area of the housing.

While in these images the sleeve portion is shown as roughly 60% of the length of the housing, it may in other instances occupy between 50-70% of the housing, less than 50% of the housing, or more than 70% the length of the housing. In some embodiments, the entire cylindrical portion of the housing is the sleeve and in still other embodiments at least 90% of the housing or at most 90% of the housing is a sleeve portion. In some embodiments, all space and components between central axis active portion 13 and the radially outward most areas of the machine may be considered active zone components, and the space considered an active zone. In that respect, the embodiment comprises each of the at least one rotor, at least one stator, and sleeve making up active zone components; an active zone extends between said active zone components; and a space gap filling substantially all of said active zone between said at least one stator and said sleeve, or in the case of certain embodiments (FIG. 10), between said at least one rotor and said sleeve.

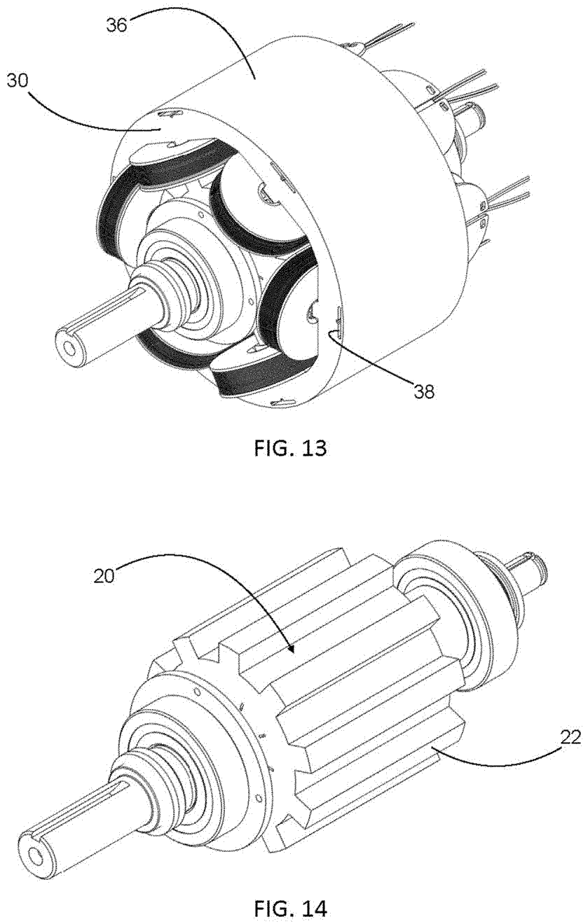

Sleeve portion 52 can be considered that portion radially outward from the stator/rotor combination, which is shown best in isolation at FIG. 13. Here, the stator 30 has an outer surface 36 that as should be apparent from the above description does not contact that portion of the housing radially outward from it. For purposes of completeness, FIG. 14 depicts a sample rotor 20 with its plurality of rotor poles 22. It should be noted that in other embodiments, such as that shown in FIG. 10, the location of these components may be switched. In diagrammatic FIG. 10, showing an alternative embodiment of the invention, SRM rotor 220 is positioned radially outward from the SRM stator 230. Stator windings/coils are identified at component 234 and the stator hub at 231. SRMs of this configuration are known in the art, however, the air gap shown just radially outward from the stator 220 is not.

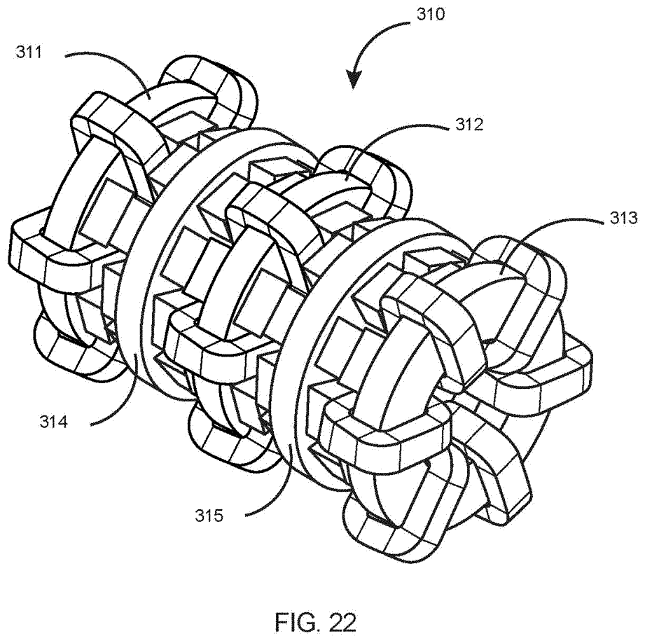

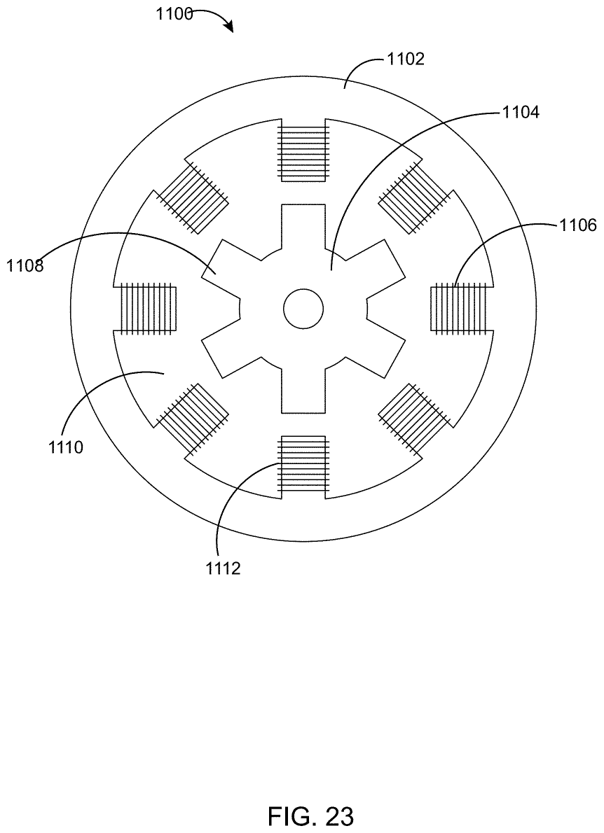

Still other embodiments, such as that shown in FIG. 22, are not incompatible with the present invention. FIG. 22 illustrates a perspective view of a multiple stator multiple rotor SRM 40 with an axial configuration having three stators 42, 44, 46 and two rotors 48, 50, all of which are radially inward of a housing (not shown). As with this case and any configuration, no part of the stator rotor stack is in direct physical communication with that portion of the housing (sleeve portion 52) radially outward from it. Said again, the stator outer surface 36 (FIG. 11) and the sleeve portion inner surface 56 are not in direct contact.

Turning now to FIG. 12, which is a rotated and zoomed view of the section shown in FIG. 11, it should become clear that stator outer surface 36 has a diameter that is smaller than the sleeve inner surface 56 of the housing 50, thus creating gap 40. The connecting bridges 60 are preferably made of aluminum and support the stator 30 while also providing a conduction path to the end plates (not shown). FIG. 12 shows at center the output shaft 16, followed by the rotor 20 radially outward, and then the stator 30 radially outward still. Gap 40 is present beyond the most radial point of either stator or rotor (see FIG. 10 wherein they are reversed). This image also shows stator apertures 38 where for clarity of understanding only, connecting bridges 60 are not threaded therethrough. As shown in other images, these connecting bridges may serve as an intermediate structure between stator/rotor and housing.

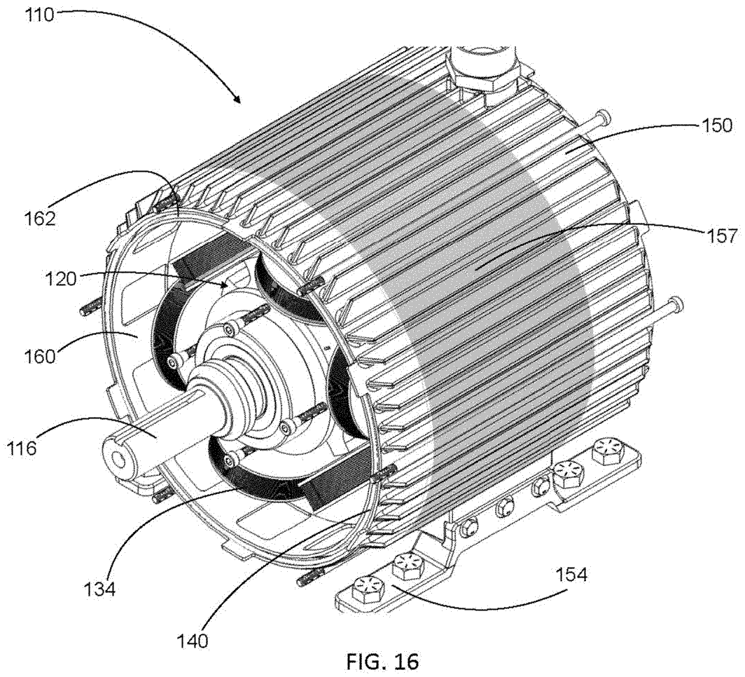

FIG. 16 is a perspective front view of an SRM 110 according to an alternative embodiment of the invention, wherein housing end plates 158 and 159, fan 114, and fan shroud 115 are shown removed for clarity. Most structures are common between all SRMs, such as output shaft 116, rotor 120, stator 130 with coils 134, and housing 150. In this embodiment, feet 154 are used to provide a tight connection of the SRM 110 to an external object (not shown).

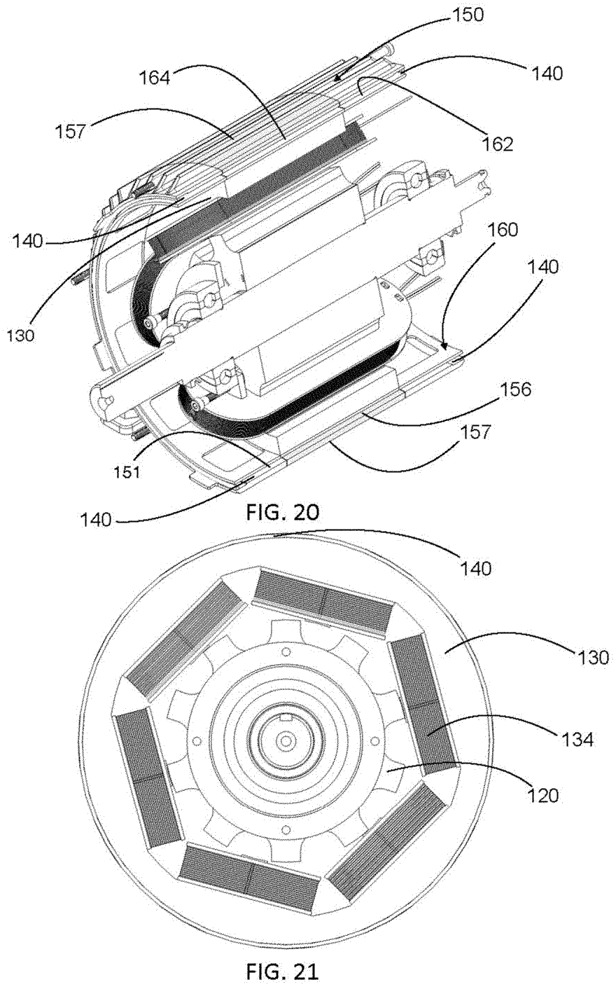

In the alternative embodiment, the intermediate structure between stator and housing is support cylinder 160 that is supported by the end plates (not shown) at each end. The cylinder has an outer diameter (support cylinder outer surface 162) smaller than the housing inner diameter, thus creating gap 140. The cylinder is preferably made of aluminum, may be perforated for lightness, and supports the stator while also providing a conduction path to the end plates. This embodiment is also compatible with the alternative embodiments shown in FIGS. 10 and 22. Conceptually, the housing 150 in this alternative embodiment has a sleeve portion with a sleeve portion outer surface 157 and a sleeve portion inner surface (shown best at FIG. 20)

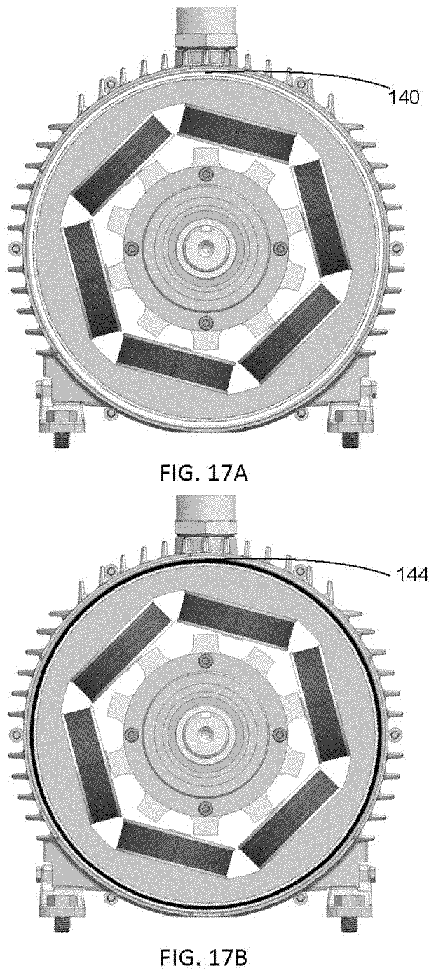

As with all embodiments, a gap between the stator/rotor stack and the inner surface of the housing is included, as is shown best at FIGS. 17A and 17B. At FIG. 17A this gap is shown as an air gap 140, whereas FIG. 17B shows it filled with an absorptive material 144.

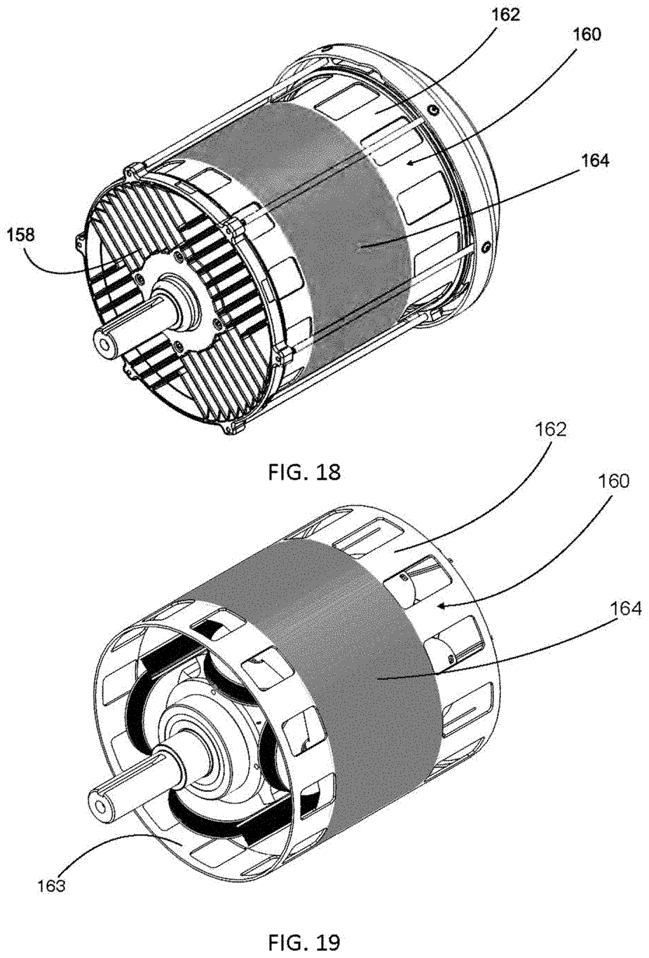

FIGS. 18 and 19 best show the support cylinder 160, along with its support cylinder outer surface 162 and support cylinder inner surface 163. The support cylinder 160 is coupled to an end cap 158 using conventional means. The sleeve portion shown with respect to the housing of this and other embodiments has an analogous component on the support cylinder. Radially inward from the sleeve portion (and radially outward from the central axis, and more specifically the central axis active portion (not labeled here)) running axially down the center of the machine, is a support cylinder sleeve zone 164. FIG. 20 is a midline cross-sectional view of the SRM 110 wherein housing end plate 158, and other components are shown removed for clarity. It is apparent from the viewing of this image that sleeve portion outer surface 157 is radially outward said stator support cylinder sleeve zone 164 and said stator 130. The support cylinder 160 has an outer surface 162 which forms the inner wall of gap 140. The outer wall of gap 140 is also depicted, here as housing inner surface 151. Where housing inner surface 151 overlaps with the stator/rotor combination, it may be referred to as sleeve portion inner surface 156. The portion of this on the outside of housing 150 is sleeve portion outer surface 157. For clarity, the components rotor 120, stator 130 (with stator windings 134) and air gap 140 are depicted again at FIG. 21.

In use, the improved SRM exhibits far less vibration and noise than conventional SRMs. Stator/rotor displacement, vibrations, and pressure waves are absorbed by the gap, gel, or other suitable material, gas and/or liquid within said gap. The stator/rotor combination is kept isolated from the housing sleeve segment radially outward of it, and the gap represents a region of noise/sound dampening around the stator/rotor. When the gap is filled with other materials, the filling may act as a further noise/sound dampening wrap, while maintaining effective heat dissipation properties enabling the switched reluctance machine to run thermally improved as compared to a conventional SRM.

While the description has not been specific to the type of SRM, in one embodiment the machine is a three-phase type as is well known in the art, and preferably in all embodiments an electrical control circuit as is well known in the art is operably attached to the windings of the stator poles. As is known conventionally, timing the energization of the windings is required for smooth operation of the SRM.

The invention may comprise in some embodiments a switched reluctance machine exhibiting reduced noise and vibration, the machine comprising a housing comprising a sleeve; a central axis comprising a central axis active portion; at least one rotor and at least one stator radially outward from said central axis, said stator comprising a stator outer surface having a stator outer surface; a gap between substantially all of said stator outer surface and said sleeve; and wherein the sleeve is radially outward from said gap, which is radially outward from said at least one stator, which is radially outward from said at least one rotor, which is radially outward from said central axis active portion.

In other embodiments, a switched reluctance machine exhibiting reduced noise and vibration is disclosed, the machine comprising at least one rotor arranged to rotate about a central axis, the at least one rotor comprising a set of rotor poles arranged about the central axis; at least one stator positioned concentric to and radially outward from both the central axis and the at least one rotor, the at least one stator comprising a set of stator poles in magnetic communication with the set of rotor poles and each having a winding, wherein at least two of said stator poles form a phase of the switched reluctance machine, and, when the phase is energized, at least one of the rotor poles aligns with a stator pole. The at least one stator further comprises a stator outer surface radially outward from said set of stator poles and having a stator outer surface, and the machine further comprises a housing comprising a sleeve portion having a sleeve inner surface and an outer sleeve surface, the sleeve located only radially outward from the stator outer surface.

In some embodiments the machine comprises a gap between substantially all of the stator outer surface and substantially all of said sleeve inner surface. In some embodiments the gap may be filled with a gas, such as air, or it may be filled with other non-gaseous vibration absorbing materials. The gap may exist between all of the stator outer surface and all of the sleeve inner surface, wherein the stator outer surface and sleeve inner surface are not contiguous.

In other embodiments the alignment between stators and rotors is maintained by a plurality of connecting bridges, and in other embodiments a plurality of connecting bridges supports said at least one stator within said sleeve. In certain of these embodiments the connecting bridges are the sole mechanical connection between said at least one stator and said sleeve. In certain others of these embodiments there is at least one connecting bridge and it is coupled to at least one housing end cap. In certain of these embodiments the at least one connecting bridge is perpendicular to the at least one housing end cap. In still other embodiments the ratio of windings to connecting bridges is 1:1, at least 1:1, or at most 1:1. In some embodiments the windings are radially aligned with said connecting bridges.

In certain other embodiments the stator is mechanically connected to the sleeve only via an intermediate structure. In certain of these, the machine further comprising a gap between substantially all said stator outer surface and the sleeve, and in some instances only the gap is between said stator outer surface and the sleeve.

In still further embodiments the stator and sleeve are not contiguous, the rotor and sleeve are not contiguous, the stator and no part of the housing is contiguous, and/or the rotor and no part of the housing is contiguous. In some embodiments the stator or rotor are not in direct connection with any part of the housing, but instead are in connection only via an intermediate object, such as a connecting bridge 60 or support cylinder 160. In still further embodiments the stator is in connection with said sleeve only through said at least one endplate and said connecting bridges. Thus, there is no direct connection, and instead only a connection via some intermediate structure.

The present invention provides a plurality of combinations of the rotor poles and stator poles utilizing a numerical relationship defined by a mathematical formula:

Rₙ=2Sₙ=Fₚ:

Where Sp=m×Fₚ, Fₚ>2, m>1 and m and Fₚ are independent variables, Rₙ is the number of rotor poles, Sₙ is the number of stator poles, Fₚ represents the maximum number of independent flux paths in the stator when stator and rotor poles are fully aligned AND Fₚ>2, m is the number of phases AND m>1 and m and Fₚ are independent variables.

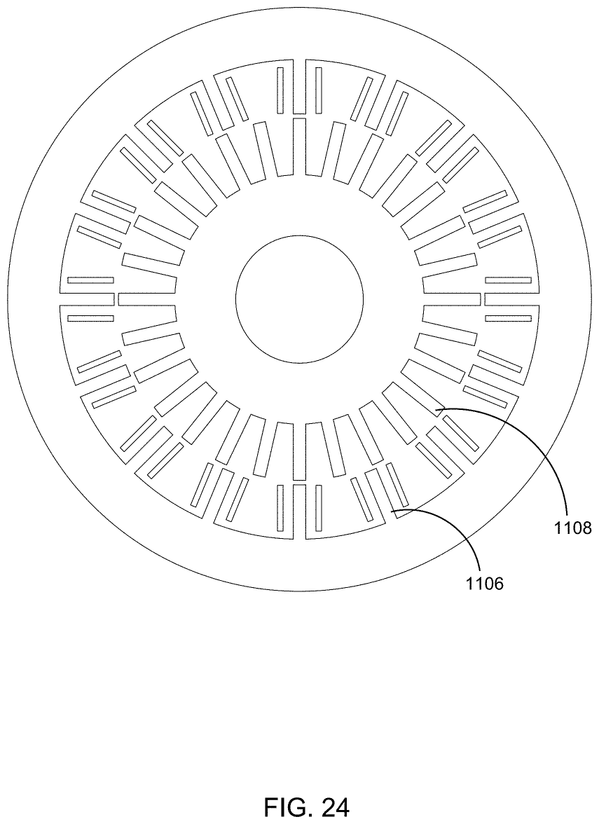

Turning first to FIG. 24, a cross-sectional view of a switched reluctance motor 1100 is illustrated. The switched reluctance motor 1100 includes a stator 1102 and a rotor 1104 that rotates inside the stator 1102. The stator 1102 includes a plurality of stator poles 1106 and the rotor 1104 includes a plurality of rotor poles 1108. As the rotor 1104 rotates, an airgap 1110 separates stator poles 1106 from rotor poles 1108. The switched reluctance motor 1100 shown in FIG. 24 is referred to as an 8/6 SRM since stator 1102 includes eight stator poles 1106 and rotor 1104 includes six rotor poles 1108. Other viable combinations of the stator poles and rotor poles of the switched reluctance motor 1100, and may benefit from the teachings of the invention. A winding 1112, for example a copper winding, is wound around each stator pole 116. The windings 1112 on diametrically opposite pairs of the stator poles 1106 are connected in series or in parallel. Phase currents are sent through the windings 1112 on pairs of stator poles 1106 connected in series or in parallel, and are turned on and off based on the angular position of the rotor 1104 with respect to the stator 1102.

Electromagnetic torque is produced in switched reluctance motor 1100 by the attraction of rotor pole(s) 1108 to the excited stator pole(s) 1106. For example, exciting the stator poles 1106 by turning on a current through the windings 1112 on stator poles 1106 creates an electromagnetic force density in air gaps 1110. Due to a tangential component of this electromagnetic force density, a rotor pole 1108 near stator pole 1106 is attracted to the stator pole 1106. Likewise, the diametrically opposite rotor pole 1108 near the stator pole 1106 is attracted to, and attempts to align itself with, the stator pole 1106. Thus, an electromagnetic torque force is produced, turning the rotor 1104 counter-clockwise.

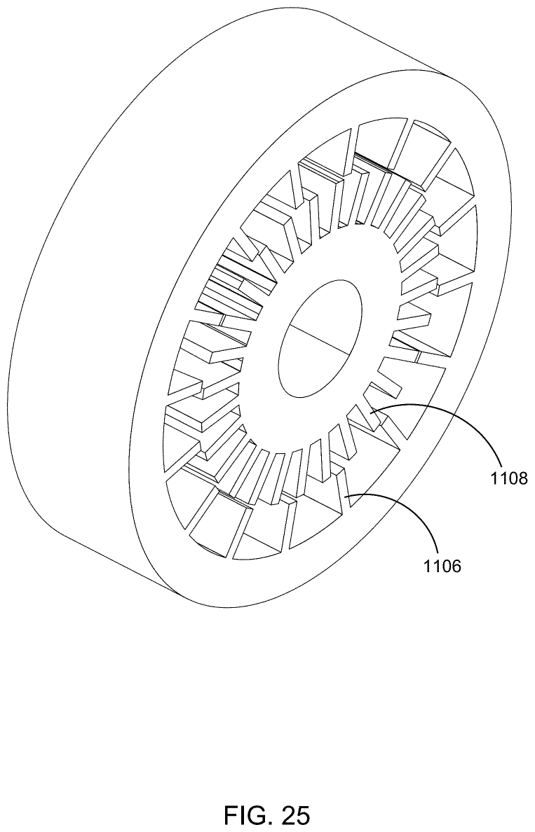

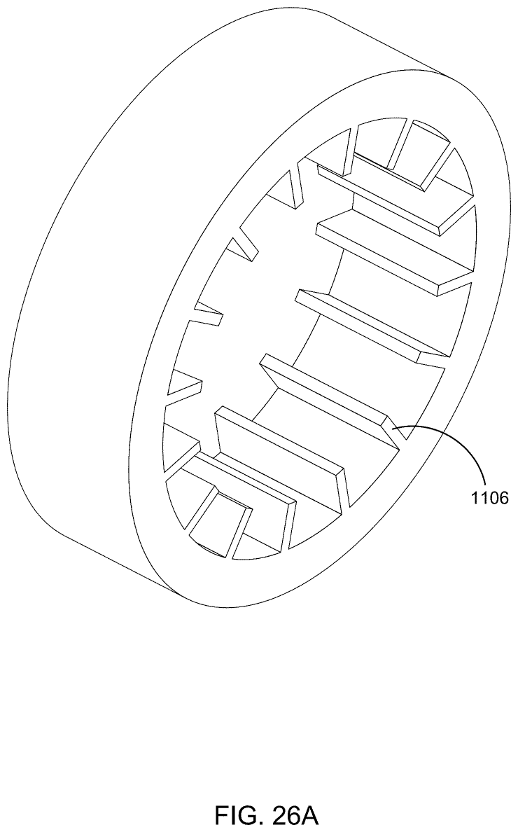

FIG. 24 illustrates a 16/28 SRM as an example of the proposed formulation with 16 concentrated stator coil-stator poles 1106 and 28 rotor poles 1108. FIG. 25 illustrates a 3-D view of 16/28 SRM as an example of the proposed formulation showing rotor and stator with 16 concentrated stator coil-stator poles 1106 and 28 rotor poles 1108.

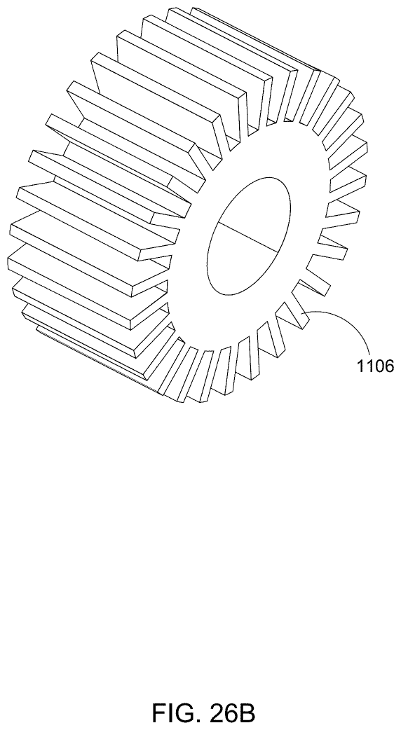

FIG. 26A shows 16 stator poles 1106 of the 16/28 SRM without coils and rotor assembly in accordance with the preferred embodiment of the present invention. FIG. 26B shows 28 rotor poles 1108 for the 16/28 SRM without stator assembly in accordance with the preferred embodiment of the present invention.

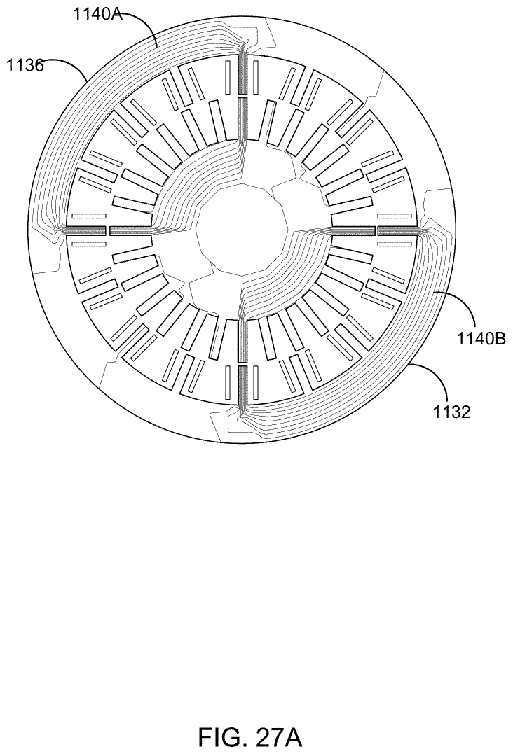

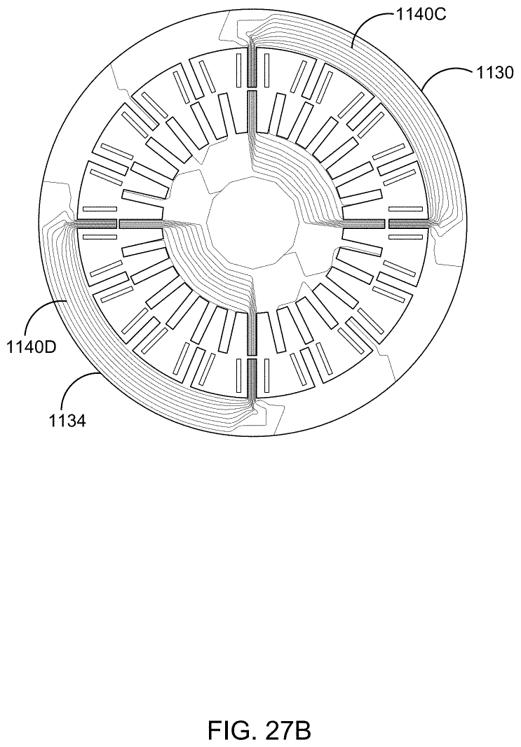

FIGS. 5A and 5B show the coil configuration in the 16/28 SRM that can be modified to allow four independent short-flux paths 1140A-1140D. FIG. 27A shows a finite element analysis simulation of 16/28 SRM showing two independent flux paths 1140A and 1140B, second quadrant 1132 and fourth quadrant 1136 in the machine. FIG. 27B shows a finite element analysis simulation of 16/28 SRM showing two other independent flux paths 1140C and 1140D, first quadrant 1130 and third quadrant 1134 in the machine. FIG. 27C shows a finite element analysis simulation of 16/28 SRM showing an alternate winding combination, also leading to four independent flux paths 1140E, 1140F, 1140G and 114011 in the machine. In yet another embodiment, the SRM is of the external-rotor internal-stator design.

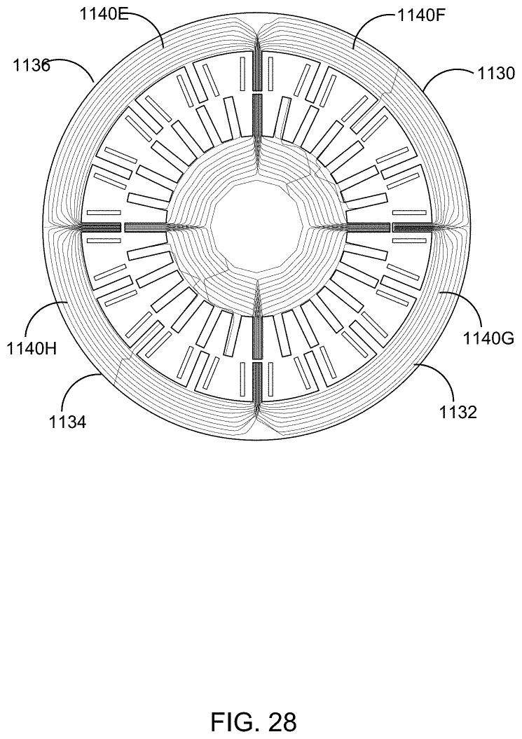

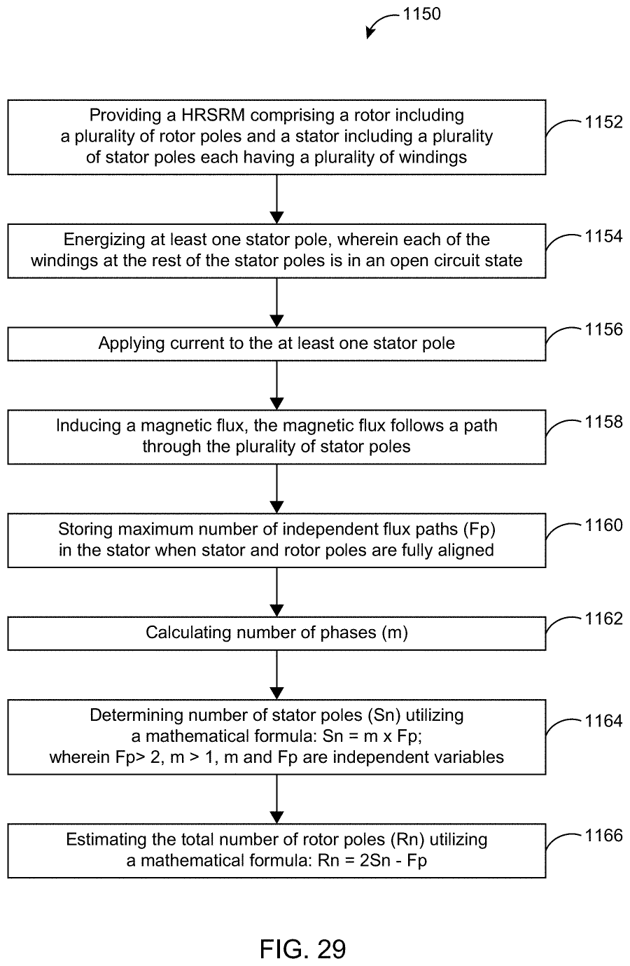

As shown in FIG. 28, a method for estimating number of rotor poles for a high rotor pole switched reluctance machine (HRSRM) comprising a rotor including a plurality of rotor poles and a stator including a plurality of stator poles each having a plurality of windings is disclosed. A first step at FIG. 28 involves providing the HRSRM comprising a rotor including a plurality of rotor poles and a stator including a plurality of stator poles each having a plurality of windings as shown in block 1152. Then, energizing at least one stator pole, wherein each of the windings of the remainder of the stator poles is in an open circuit state as illustrated in block 1154. Current is applied to the at least one stator pole as illustrated in block 1156. Next, inducing a magnetic flux, the magnetic flux follows a path through the plurality of stator poles as shown in block 1158. Storing a maximum number of independent flux paths (Fₚ) in the stator when stator and rotor poles are fully aligned as illustrated in block 1160. Then, calculating a number of phases (m) as illustrated in block 1162. Finally, determining a number of stator poles (Sₙ) utilizing a mathematical formula, Sₙ=m×Fₚ, wherein Fₚ>2, m>1, m and Fₚ are independent variables is illustrated in block 1164. Thus, estimating the number of rotor poles (Rₙ) utilizing a mathematical formula, Rₙ=2Sₙ−Fₚ is accomplished as illustrated in block 1166.

The present invention relates to a switched reluctance machine (SRM) in which noise and vibration generated can be reduced through an improvement of the rotor pole/stator pole configuration. The improved configuration provides a higher rate of change of inductance with respect to rotor position, which can improve the torque quality of the machine. The system provides a switched reluctance machine having salient rotor poles and stator poles in a numerical relationship. The proposed formulation presents a mathematical formulation, with a specific number of stator and rotor poles for a chosen m and Fp, which provides improved noise performance and design flexibility. In one example, when m=4, a machine with four phases and Fp=4 a machine with four possible independent flux paths, a 16/28 SRM results.

TABLE 1
Some, but not all viable combinations of stator poles and rotor
poles using the proposed formulation with m = 4 are as follows:

| Number of phases (m) | 4 | |
|---|---|---|
| Fₚ | Sₙ | Rₙ |
| 3 | 12 | 21 |
| 4 | 16 | 28 |
| 5 | 20 | 35 |
| 6 | 24 | 42 |
| 7 | 28 | 49 |
| 8 | 32 | 56 |
| 9 | 36 | 63 |
| 10 | 40 | 70 |
| 11 | 44 | 77 |
| 12 | 48 | 84 |
| 13 | 52 | 91 |
| 14 | 56 | 98 |
| 15 | 60 | 105 |
| 16 | 64 | 112 |
| 17 | 68 | 119 |
| 18 | 72 | 126 |
| 19 | 76 | 133 |
| 20 | 80 | 140 |

The embodiment of this formulation can be described by several other viable combinations of stator poles and rotor poles. Utilizing the proposed formulation, it is possible to design machines with varying number of phases and stator/rotor configurations. The present invention provides an SRM with applications for both rotary or linear designs, and which comprises a relationship between the number of stator poles and rotor poles so as to provide an SRM with a minimal amount of torque ripple and acoustic noise while providing improved power density and torque production. In particular, the present invention provides an SRM having a salient rotor and stator pole numerical relationship of number of stator poles Sn, and number of rotor poles Rn, which can be expressed as Rₙ=2Sₙ−Fₚ, such as an Sₙ/Rₙ pole count in a 16/28 configuration. The present invention provides an SRM, whether operated as a motor, generator, or both. The proposed topologies have the highest inductance when aligned and the lowest at unaligned positions, much like a conventional SRM. All conventional power electronic converters and control strategies adopted for conventional SRMs can be applied to the proposed SRM. The proposed SRM exhibits a smoother torque profile due to the higher number of strokes per revolution. This offers better peak and average torque profiles relative to conventional SRMs. The narrower stator pole facilitates a larger fill factor i.e. more windings, which considerably improves the winding resistance and the thermal limits of the phase windings.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

I claim:

1. An electrical machine comprising:
a. at least one rotor arranged to rotate about a central axis, the at least one rotor comprising a plurality of rotor poles arranged about the central axis;
b. at least one stator positioned concentric to and radially outward from both the central axis and the at least one rotor, the at least one stator comprising:
i. a plurality of stator poles in magnetic communication with the plurality of rotor poles and each having a winding; and
ii. a stator outer surface radially outward from said plurality of stator poles and having a stator outer surface;
c. a housing having a sleeve positioned only radially outward from the stator outer surface;
d. at least one housing endplate coupled to an end of said housing; and
e. wherein said stator is in connection with said sleeve only through said at least one endplate;
f. wherein the plurality of rotor poles is in a numerical relationship with the plurality of stator poles defined by a mathematical formula: R ₙ=2S ₙ−F ₚ;
g. such that Sₙ=m×Fₚ, Fₚ>2, m>1 wherein Rₙ is the number of rotor poles, Sₙ is the number of stator poles, Fₚ is the maximum number of independent flux paths in the stator when stator and rotor poles are fully aligned, and m is the number of phases, and wherein Fₚ is even.

2. The switched reluctance machine of claim 1 wherein said housing comprises mounting feet.

3. The switched reluctance machine of claim 2 wherein said feet are located on the end plate.

4. The switched reluctance machine of claim 1 further comprising an electrical control circuit operably attached to the windings of the stator poles.

5. The electrical machine according to claim 1 wherein the mathematical formulation provides a specific number of stator and rotor poles for a chosen m and Fp.

6. The electrical machine according to claim 1 wherein each rotor pole constitutes a plurality of flux guides which serve to bend the flux in the stator pole around a periphery of the rotor pole.

7. The electrical machine of claim 1 wherein the machine is a linear generator.

8. The electrical machine of claim 1 wherein the machine is a linear motor.

9. The electrical machine of claim 1 wherein the machine is a rotary generator.

10. The electrical machine of claim 1 wherein the machine is a rotary motor.

11. An electrical machine comprising:
a. a housing comprising a sleeve;
b. a central axis comprising a central axis active portion;
c. at least one rotor and at least one stator radially outward from said central axis, said stator comprising a stator outer surface having a stator outer surface;
d. a gap between substantially all of said stator outer surface and said sleeve; and
e. wherein the sleeve is radially outward from said gap, and only said sleeve and gap are radially outward from said at least one stator, which is radially outward from said at least one rotor, which is radially outward from said central axis active portion; and
f. wherein the plurality of rotor poles is in a numerical relationship with the plurality of stator poles defined by a mathematical formula: R ₙ=2S ₙ−Fₚ;
g. such that Sₙ=m×Fₚ, Fₚ>2, m>1 wherein Rₙ is the number of rotor poles, Sₙ is the number of stator poles, Fₚ is the maximum number of independent flux paths in the stator when stator and rotor poles are fully aligned, and m is the number of phases, and wherein Fₚ is even.

12. The switched reluctance machine of claim 11, further comprising:
a. a plurality of rotor poles on said at least one rotor;
b. a plurality of stator poles in magnetic communication with the plurality of rotor poles and each having a winding; and

13. The switched reluctance machine of claim 11 further comprising an electrical control circuit operably attached to the windings of the stator poles.

14. The switched reluctance machine of claim 11 wherein the gap is substantially filled with air.

15. The switched reluctance machine of claim 11 wherein the gap is substantially filled with a non-gaseous vibration absorbing material.

16. The switched reluctance machine of claim 11 where the gap is between all of the stator outer surface and all of the sleeve inner surface, and wherein the stator outer surface and sleeve inner surface are not contiguous.

17. The electrical machine according to claim 11 wherein the mathematical formulation provides a specific number of stator and rotor poles for a chosen m and Fp.

18. The electrical machine according to claim 11 wherein each rotor pole constitutes a plurality of flux guides which serve to bend the flux in the stator pole around a periphery of the rotor pole.

19. The electrical machine of claim 11 wherein the machine is a linear generator.

20. The electrical machine of claim 11 wherein the machine is a linear motor.

21. The electrical machine of claim 11 wherein the machine is a rotary generator.

22. The electrical machine of claim 11 wherein the machine is a rotary motor.

23. An electrical machine comprising:
a. at least one rotor arranged to rotate about a central axis, the at least one rotor comprising a plurality of rotor poles arranged about the central axis;
b. at least one stator positioned concentric to and radially outward from both the central axis and the at least one rotor, the at least one stator comprising:
i. a plurality of stator poles in magnetic communication with the plurality of rotor poles and each having a winding;
ii. a stator outer surface radially outward from said plurality of stator poles and having a stator outer surface;
c. a housing comprising a sleeve portion having a sleeve inner surface and an outer sleeve surface, the sleeve located only radially outward from the stator outer surface; and
d. a gap between substantially all of the stator outer surface and substantially all of said sleeve inner surface; and
e. wherein the plurality of rotor poles is in a numerical relationship with the plurality of stator poles defined by a mathematical formula: R ₙ=2S ₙ−Fₚ;
f. such that Sₙ=m×Fₚ, Fₚ>2, m>1 wherein Rₙ is the number of rotor poles, Sₙ is the number of stator poles, Fₚ is the maximum number of independent flux paths in the stator when stator and rotor poles are fully aligned, and m is the number of phases, and wherein Fₚ is even.

24. The switched reluctance machine of claim 23 where the gap is between all of the stator outer surface and all of the sleeve inner surface, and wherein the stator outer surface and sleeve inner surface are not contiguous.

25. The switched reluctance machine of claim 23 wherein an alignment between stators and rotors is maintained by a plurality of connecting bridges.

26. The switched reluctance machine of claim 23 further comprising an electrical control circuit operably attached to the windings of the stator poles.

27. The electrical machine according to claim 23 wherein the mathematical formulation provides a specific number of stator and rotor poles for a chosen m and Fp.

28. The electrical machine according to claim 23 wherein each rotor pole constitutes a plurality of flux guides which serve to bend the flux in the stator pole around a periphery of the rotor pole.

29. The electrical machine of claim 23 wherein the machine is a linear generator.

30. The electrical machine of claim 23 wherein the machine is a linear motor.

31. The electrical machine of claim 23 wherein the machine is a rotary generator.

32. The electrical machine of claim 23 wherein the machine is a rotary motor.
